(19) United States
(12) Patent Application Publication
(10) Pub. No.: US 2001/0020790 A1
(43) Pub. Date: Sep. 13, 2001

(54) Latch mechanism

(75) Inventors: Sydney Edward Fisher, West Midlands (GB); Axel Fauveau, Tamworth (GB)

Correspondence Address: Karin H. Butchko, CARLSON, GASKEY & OLDS, P.C., Suite 350, 400 W. Maple Road, Birmingham, MI, 48009, US

(73) Assignee: Meritor Light Vehicle Systems (UK) Limited

(21) Appl. No.: 09/784,465

(22) Filed: Feb. 15, 2001

(30) Foreign Application Priority Data
Feb. 18, 2000 (GB) GB0003689.7

(51) Int. Cl. E05C 3/06

(52) U.S. Cl. 292/216

(57) ABSTRACT

A vehicle door latch mechanism including a latch bolt adapted to releasably secure a striker. In use, the latch bolt is pivotably mounted to a chassis of the latch mechanism and movable between an open position and a closed position. The latch mechanism further includes a detent mechanism adapted to releasably maintain the latch bolt in the open position. By providing such a detent mechanism the need for a dedicated latch bolt, a return spring is eliminated.

### BACKGROUND OF THE INVENTION

The present invention relates generally to a latch mechanism for motor vehicle doors.

A typical vehicle door latch mechanism essentially comprises a rotatable claw mounted on a vehicle door which co-operates with a striker pin mounted on the vehicle body. The action of closing the door causes the claw to rotate to a closed position whereupon it engages and retains the striker pin. The claw is maintained in a closed position by a sprung pawl which abuts an appropriately shaped portion of the claw. The latch typically includes a claw return spring which holds the claw in an open position ready to receive the striker pin before the door is closed.

It is desirable to eliminate this return spring so as to reduce the number of components in the latch mechanism. This consequently makes the latch mechanism cheaper and easier to manufacture. Further, the latch mechanism assembly can be made smaller, or alternatively the space vacated by elimination of the spring used to house one or more other components of the latch assembly.

Hence, there is a need in the art for an improved a latch mechanism for motor vehicle doors

### SUMMARY OF THE INVENTION

The present invention relates generally to a latch mechanism for motor vehicle doors.

According to the present invention, there is provided a vehicle door latch mechanism having a latch bolt adapted to releasably secure a striker. In use, the latch bolt is mounted to a chassis of the latch mechanism and is movable between an open position and a closed position. The latch mechanism further includes a detent mechanism adapted to releasably maintain the latch bolt in the open position. The provision of a detent mechanism eliminates the need for a dedicated latch bolt return spring to be included in the latch mechanism.

In one embodiment, the detent mechanism is provided by a recess on either the latch bolt and chassis and a corresponding projection of the other. Preferably, the recess is provided in the latch bolt and the projection on the chassis. In such an embodiment, the projection extends laterally from a side of the chassis and the recess is provided in a facing side of the latch bolt.

The projection may be provided on a portion of a retention plate of the chassis. In such an embodiment, the portion of the retention plate has a reduced wall thickness when compared to the main body of the retention plate, so as enable resilient deformation in use. Preferably, the projection is provided with a rounded edge adapted to engage the recess of the latch bolt.

In an alternative embodiment, the detent mechanism is provided by a pawl of the latch mechanism and a corresponding pawl engagement recess of the latch bolt. Preferably, the pawl is adapted so as to also releasably secure the latch bolt in the closed position, in use. Preferably, the pawl engagement recess is provided in an edge of the latch bolt.

Accordingly, the present invention provides a latch mechanism for motor vehicle doors.

These and other features of the present invention will be best understood from the following specification and drawings.

### BRIEF DESCRIPTION OF THE DRAWINGS

The various features and advantages of the invention will become apparent to those skilled in the art from the following detailed description of the currently preferred embodiment. The drawings that accompany the detailed description can be briefly described as follows:

FIG. 1 shows a side view of a first embodiment of a latch mechanism wherein the pawl is provided above the claw.

FIG. 2 shows the cross-sectional view indicated by arrows A-A in FIG. 1.

FIG. 3 shows a side view of another embodiment of a latch mechanism wherein the pawl is provided below the claw.

### DETAILED DESCRIPTION OF THE PREFERRED EMBODIMENT

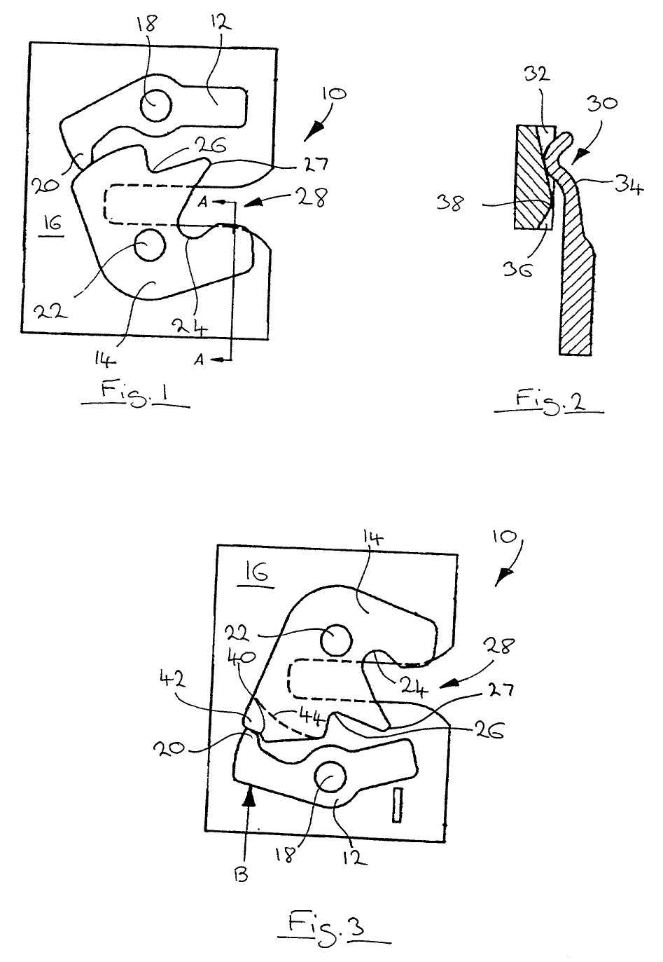

FIG. 1 illustrates a latch mechanism generally designated 10. The mechanism 10 includes a pawl 12, a latch bolt in the form of a claw 14, and a retention plate 16. The pawl 12 is pivotally mounted above the claw 14 via a pawl pin 18 which is in turn connected to the retention plate 16. The pawl 12 includes a pawl engagement portion 20.

The retention plate 16, in conjunction with further components of the latch mechanism 10 which do not move relative to the retention plate 16 during use, form a chassis of the latch mechanism 10.

The claw 14 is pivotally mounted on a claw pin 22, which is secured to the retention plate 16. The claw 14 includes a claw jaw 24 and a claw first safety engagement portion 26 and a claw closed engagement portion 27. In FIG. 1, the claw 14 is shown in an open position. The retention plate 16 includes a mouth 28 adapted to receive a striker pin.

In use, the claw jaw 14 releasably secures the striker pin in the mouth 28 of the retention plate 16. The claw 14 can be secured in its first safety position by abutment of the pawl engagement portion 20 with the claw first safety engagement portion 26. In this position, an associated door is secured from opening though is not in a fully closed position, and the claw 14 can be secured in its closed position, by abutment of the pawl engagement portion 20 with the claw closed engagement portion 27.

The claw 14 is held in the open position by the provision of a detent mechanism. In FIG. 1, the detent mechanism is provided by a sprung latch 30 of the retention plate 16 which co-operates with a corresponding latch recess 32 of the claw 14 when the claw 14 is in the open position. As illustrated in FIG. 2, a portion 34 of the retention plate 16 corresponding to a lower edge of the mouth 28 is formed so as to bulge laterally towards the claw 14. The thickness of the retention plate 16 in the region of the latch 30 is reduced so as to permit resilient movement thereof. The side of the claw 14 facing the retention plate 16 is provided with ramped recesses 32, 36 sharing a common apex 38. The shallower latch recess 32 is adapted to receive the latch 30 and hold the claw 14 in the open position. The steeper recess 36 is provided so as to smooth the transition of the latch 30 to and from the latch recess 32 as the claw 14 pivots about the claw pin 22 in use.

It is also to be understood that the latch mechanism 10 may be formed such that the recess is located on the retention plate 16 and a projection is formed on the claw 14.

A second embodiment of the present invention is illustrated in FIG. 3. Components common to the first embodiment are identified with like numerals. In this embodiment, the pawl 12 is positioned below the claw 14. The detent mechanism in this embodiment is provided by the pawl engagement portion 20 and an appropriately shaped pawl recess 40 on the claw 14. The pawl recess 40 is provided in an extended lobe 42 of the claw 14, the profile of a typical claw being shown by broken line 44. A resilient force, indicated by arrow B, to retain the pawl engagement portion 20 in the pawl recess 40, and hence the claw 14 in the open position, is provided by the pawl spring. It will be understood that the profile of the pawl recess 40 is such that the pawl engagement portion 20 is released therefrom when the claw 14 is caused to rotate to the closed position.

The foregoing description is only exemplary of the principles of the invention. Many modifications and variations of the present invention are possible in light of the above teachings. The preferred embodiments of this invention have been disclosed, however, so that one of ordinary skill in the art would recognize that certain modifications would come within the scope of this invention. It is, therefore, to be understood that within the scope of the appended claims, the invention may be practiced otherwise than as specially described. For that reason the following claims should be studied to determine the true scope and content of this invention.

What is claimed is:

1. A vehicle door latch mechanism comprising:
a latch bolt adapted to releasably secure a striker, said latch bolt being mounted to a chassis and movable between an open position and a closed position; and
a detent mechanism adapted to releasably maintain said latch bolt in said open position.

2. The latch mechanism as recited in claim 1 wherein said detent mechanism includes a recess on said latch bolt and a corresponding projection on said chassis.

3. The latch mechanism as recited in claim 2 wherein said projection extends laterally from a side of said chassis and said recess is provided in a facing side of said latch bolt.

4. The latch mechanism as recited in claim 3 wherein said projection is provided on a portion of a retention plate of said chassis.

5. The latch mechanism as recited in claim 5 wherein said portion of said retention plate has a reduced wall thickness as compared to a main body of said retention plate, enabling resilient deformation thereof.

6. The latch mechanism as recited in claim 2 wherein said projection includes a rounded edge adapted to engage said recess.

7. The latch mechanism as recited in claim 1 wherein said detent mechanism includes a recess on said chassis and a corresponding projection on said latch bolt.

8. The latch mechanism as recited in claim 1 wherein said latch mechanism further includes a pawl and said detent mechanism is provided by said pawl and a corresponding pawl engagement recess on said latch bolt.

9. The latch mechanism as recited in claim 8 wherein said pawl is adapted so as to also releasably secure said latch bolt in use in said closed position.

10. The latch mechanism as recited in claim 8 wherein said pawl engagement recess is provided on an edge of said latch bolt.

11. A vehicle door comprising:
latch bolt adapted to releasably secure a striker, said latch bolt being mounted to a chassis of said vehicle and movable between an open position and a closed position;
a pawl which engages and secure said latch bolt; and
and a detent mechanism adapted to releasably maintain said latch bolt in said open position
